(19) United States
(12) Patent Application Publication
(10) Pub. No.: US 2003/0044666 A1
(43) Pub. Date: Mar. 6, 2003

(54) Chemical barriers in electrochemical devices

(76) Inventors: Qinbai Fan, Chicago, IL (US); Joseph Herron, Naperville, IL (US)

Correspondence Address: Mark E Fejer, Gas Technology Institute, 1700 South Mount Prospect Road, Des Plaines, IL, 60018, US

(21) Appl. No.: 09/982,067

(22) Filed: Oct. 17, 2001

Related U.S. Application Data
(63) Continuation-in-part of application No. 09/946,192, filed on Sep. 5, 2001.

(51) Int. Cl. H01M 8/10

(52) U.S. Cl. 429/30; 429/126; 429/33; 429/15

(57) ABSTRACT

An electrochemical device having an electrolyte having an anode side and a cathode side, at least one consumable carbonaceous material disposed on the anode side, and a chemical barrier disposed on the anode side of the electrolyte, which chemical barrier reduces crossover of the at least one consumable carbonaceous material through the electrolyte to the cathode side. In accordance with one preferred embodiment, the electrochemical device is a direct methanol fuel cell, the consumable carbonaceous material is methanol disposed in an aqueous solution, and the chemical barrier is produced by the presence of an additive disposed in the methanol solution which attaches to potential methanol crossover sites in the electrolyte, thereby precluding methanol crossover using such sites. One such suitable additive is iso-propanol.

### CROSS REFERENCE TO RELATED APPLICATION

This application is a continuation-in-part application of a co-pending U.S. patent application having Serial No. 09/946,192 filed Sep. 5, 2001.

### BACKGROUND OF THE INVENTION

1. Field of the Invention

This invention relates to electrochemical devices, more particularly to electrochemical devices in which a carbonaceous material undergoes oxidation to produce chemicals and/or electricity. This invention also relates to a method for substantially preventing the crossover of some of the carbonaceous material from one side of the electrolyte through the electrolyte to the other side of the electrolyte of the electrochemical devices.

2. Description of Related Art

An electrochemical device is a device in which a chemical or chemical compound is modified by electronic means to produce other chemicals and/or electricity. Exemplary of devices which produce electricity are fuel cells, which comprise an anode electrode, a cathode electrode and an electrolyte disposed between the anode electrode and the cathode electrode, in which a fuel such as hydrogen or carbonaceous materials such as methane, methanol, ethane, butane, etc. is introduced into the anode side of the electrolyte and an oxidant, such as air, is introduced into the cathode side of the electrolyte and the fuel and oxidant are reacted, resulting in the generation of electricity. Typically, the carbonaceous fuels are reformed to produce hydrogen which is then introduced into the fuel cell. However, it will be apparent that fuel cells which are capable of direct utilization of carbonaceous fuels are a desirable objective since the need for reforming would be eliminated.

There exist different types of fuel cells defined, in part, on the basis of the type of electrolyte employed. Molten carbonate fuel cells employ molten carbonates disposed in an electrolyte matrix as an electrolyte; phosphoric acid fuel cells employ phosphoric acid as an electrolyte; solid oxide fuel cells employ solid electrolytes; and polymer electrolyte membrane fuel cells employ, as the name suggests, polymeric membranes as an electrolyte.

Direct methanol polymer electrolyte membrane fuel cells are prime candidates for both vehicular and stationary uses due to their inherent simplicity (no external reformers) and potential high energy densities (liquid fuels). In addition, direct methanol polymer electrolyte membrane fuel cells have the potential for replacing rechargeable batteries due to the possibility of a zero recharge time. However, the current state of the art in direct methanol polymer electrolyte membrane fuel cells requires external means, such as pumps and blowers for introducing reactants into and removing reaction products from the fuel cell. For example, U.S. Pat. No. 5,573,866 to Van Dine et al. teaches a polymer electrolyte membrane fuel cell which directly oxidizes liquid methanol fuel that is fed into the anode chamber from a liquid methanol storage container. The liquid methanol is mixed with water in the anode chamber. Some of the methanol and water cross over the membrane into the cathode chamber and into a process air stream. The methanol and water are removed from the cathode chamber by evaporation into the process air stream, which is then directed into a condenser/radiator. The methanol and water vapors are condensed in the condenser/radiator, from whence the condensed water and methanol are returned to the anode chamber of the cell. The evaporating cathode process air stream, which is provided to the cathode chamber by means of a fan, provides oxygen for the fuel cell reaction, and also cools the cell.

As can be seen, methanol is capable of passing through, or crossing over, the polymer electrolyte membrane from the anode side to the cathode side. Methanol crossover from the anode to the cathode is generally undesirable as it reduces the attainable cell voltage because the methanol “oxidizes” at the cathode. Under the current state of the art, physical barriers, such as inorganic powders, organic copolymers and inorganic ion doping are used to reduce the methanol crossover. However, such physical barriers have not been shown to be totally effective. In addition, physical barriers, while reducing methanol crossover, also undesirably reduce proton conductivity.

### SUMMARY OF THE INVENTION

It is, thus, one object of this invention to provide a method for reducing fuel crossover from the anode to the cathode in a direct-fuel type fuel cell.

It is one object of this invention to provide a direct-fuel type fuel cell, such as a direct methanol fuel cell, in which fuel crossover is substantially reduced without employing physical barriers.

It is one object of this invention to provide a method for reducing methanol crossover in a direct methanol fuel cell without reducing proton conductivity.

These and other objects of this invention are addressed by an electrochemical device comprising an electrolyte having an anode side and a cathode side, at least one consumable carbonaceous material disposed on the anode side, and crossover means for reducing crossover of the at least one consumable carbonaceous material through the electrolyte to the cathode side, which crossover means comprises a chemical barrier disposed on the anode side of the electrolyte. Without wishing to be bound by any one explanation as to the operation of the chemical barrier to reduce fuel crossover through the polymer electrolyte membrane, it is believed that the chemical barriers employed in this invention “occupy” what would otherwise be fuel crossover sites on the membrane, thereby precluding the fuel from reaching the sites and crossing over onto the cathode side of the electrolyte. We have, however, found that the chemical compounds employed as chemical barriers are not consumed and, thus, require substantially no replenishment.

### BRIEF DESCRIPTION OF THE DRAWINGS

These and other objects and features of this invention will be better understood from the following detailed description taken in conjunction with the drawings, wherein:

FIG. 1 is a diagram of an exemplary reaction scheme for formation of a chemical barrier in a direct methanol fuel cell in accordance with one embodiment of this invention;

FIG. 2 is a simplified diagram of a direct methanol fuel cell system for testing the addition of various chemical additives to the methanol fuel for forming a chemical barrier; and

FIG. 3 is a diagram showing the performance of a direct methanol fuel cell employing varying amounts of methanol in solution and varying amounts of chemical additives for formation of a chemical barrier.

### DETAILED DESCRIPTION OF THE PRESENTLY PREFERRED EMBODIMENTS

The invention claimed herein is an electrochemical device comprising an electrolyte having an anode side and a cathode side, at least one consumable carbonaceous material disposed on the anode side, and crossover means for reducing crossover of the at least one consumable carbonaceous material through the electrolyte to the cathode side. In contrast to conventional systems in which physical barriers are employed as the crossover means for reducing crossover of the at least one consumable carbonaceous material through the electrolyte to the cathode side, this invention employs chemical barriers, which, in addition to substantially preventing crossover of the at least one consumable carbonaceous material crossover, do not significantly reduce proton conductivity. In operation, the consumable carbonaceous material utilized in the electrochemical device is disposed in an aqueous solution. The concept of this invention is the addition of one or more additives to the solution which result in the formation of a chemical barrier proximate the electrolyte. In the exemplary embodiment discussed herein, the consumable carbonaceous fuel is methanol and the electrochemical device is a direct methanol fuel cell comprising an anode electrode, a cathode electrode and a polymer electrolyte membrane disposed therebetween. A condensation reaction of an alcohol with an acid produces an ester and water, e.g. CH₃OH+C₆H₅COOH⇄CH₃OOCC₆H₅+H₂O. The reaction is an equilibrium and is slow under normal conditions. It can, however, be speeded up by addition of a strong acid catalyst. NAFION is a fluoro-sulfuric acid, which reacts with methanol to form an ester. This reaction is slow; however, in the NAFION membrane, due to the high concentration of acid present therein, the reaction can be fast. In the direct methanol fuel cell, the methanol crossover is one factor that reduces the cell performance. That methanol reacts with NAFION and stays in the NAFION is another reason to increase cell IR. The condensation reaction is used, in accordance with one embodiment of this invention, to provide a chemical barrier, which reduces methanol crossover.

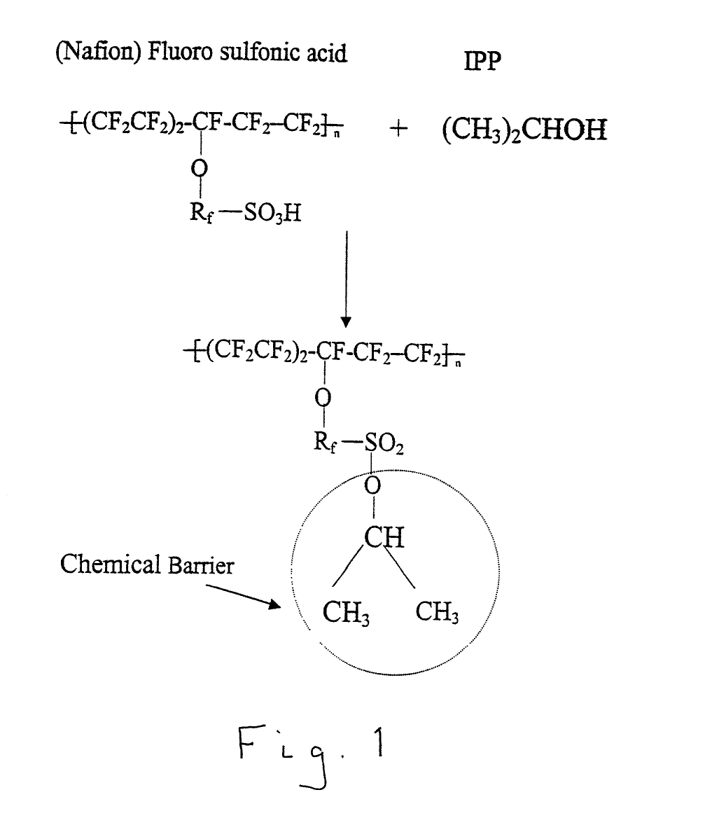

FIG. 1 is a diagram showing a reaction scheme for formation of a chemical barrier in accordance with one embodiment of this invention. Iso-propanol (IPP) is a three-carbon molecule that is very difficult to oxidize to carbon dioxide and water. As shown in FIG. 1, IPP acts as a “T”-shaped chemical barrier, occupying sites on which methanol might otherwise sit. Other molecules, such as ethylene glycol, butanol, etc. are also candidates for use as chemical barriers. However, physical properties, such as viscosity and solubility, must also be considered in choosing a suitable candidate molecule for chemical barrier formation. The properties of the additives must be stable, not poison the catalysts, and not restrict proton movements. As previously stated, the chemical barrier is in equilibrium in the methanol solution, but is not consumed. Thus, in the direct methanol fuel cell, only the methanol fuel is consumed.

To evaluate the effectiveness of adding various additives to the methanol solution, a test setup, shown in FIG. 2, was constructed. A direct methanol fuel cell 20 was assembled using a membrane-electrode assembly (MEA) comprising a 25 micron thick polymeric membrane. A clamp was used to hold the cell. The anode was a stainless steel foam that acts as a methanol diffuser and the cathode was also a stainless steel foam that functioned as an air supplier. Because the holding force of this test cell was low and not uniform, its performance as a cell was low.

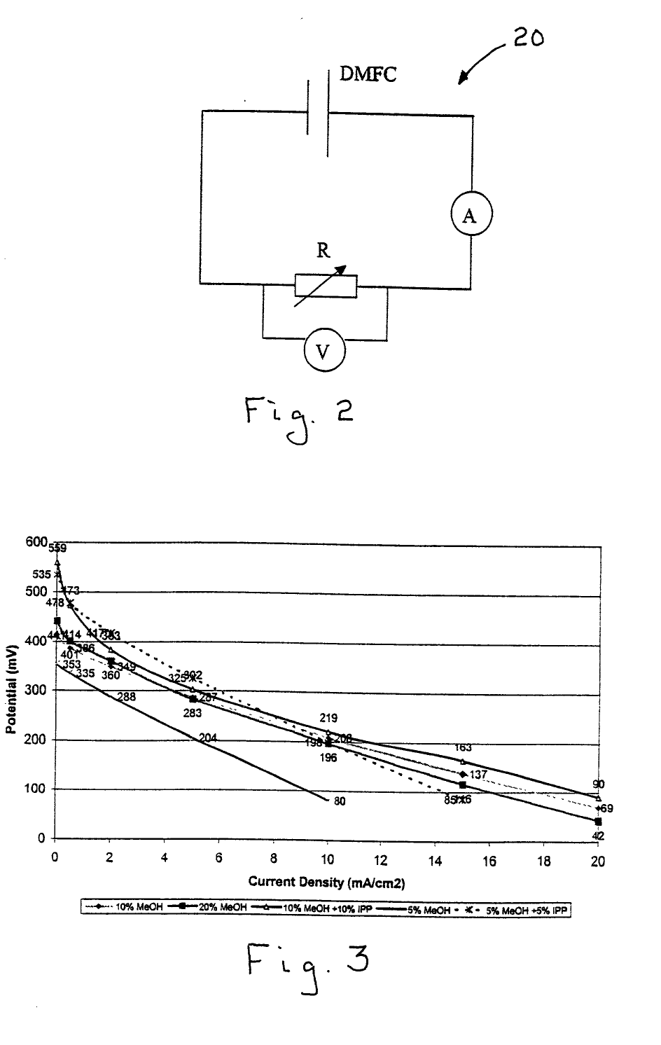

FIG. 3 shows the effects of the presence of iso-propanol in the methanol solution, as well as varying the concentration of methanol in the solution, on the performance of the direct methanol fuel cell. As can be seen when comparing the curves for 10% and 20% methanol solutions without additives, as the concentration of methanol in the solution increases, performance of the cell decreases, presumably due to the amount of methanol crossover occurring. However, adding 10% by volume iso-propanol to the 10% methanol solution resulted in a substantial improvement in cell performance. The substantial difference in OCV demonstrates the occurrence of a decrease in methanol crossover.

While in the foregoing specification this invention has been described in relation to certain preferred embodiments thereof, and many details have been set forth for the purpose of illustration, it will be apparent to those skilled in the art that the invention is susceptible to additional embodiments and that certain of the details described herein can be varied considerably without departing from the basic principles of this invention.

We claim:

1. In an electrochemical device comprising an electrolyte having an anode side and a cathode side, at least one consumable carbonaceous material disposed on said anode side, and crossover means for reducing crossover of said at least one consumable carbonaceous material through said electrolyte to said cathode side, the improvement comprising:
said crossover means comprising a chemical barrier disposed on said anode side of said electrolyte.

2. An electrochemical device in accordance with claim 1, wherein said chemical barrier comprises at least one substantially non-consumable chemical additive disposed in said at least one consumable carbonaceous material.

3. An electrochemical device in accordance with claim 1, wherein said electrolyte is a solid comprising a plurality of crossover sites suitable for crossover of said at least one consumable carbonaceous material through said electrolyte.

4. An electrochemical device in accordance with claim 3, wherein said chemical barrier comprises at least one chemical additive suitable for attachment to at least a portion of said plurality of crossover sites.

5. An electrochemical device in accordance with claim 1, wherein said chemical barrier comprises a chemical additive comprising at least one organic molecule that is larger than a molecule of said at least one consumable carbonaceous material.

6. An electrochemical device in accordance with claim 4, wherein said at least one consumable carbonaceous material is methanol.

7. An electrochemical device in accordance with claim 6, wherein said at least one chemical additive comprises at least one organic compound having a molecular size that is larger than a molecular size of said methanol.

8. An electrochemical device in accordance with claim 7, wherein said at least one chemical additive comprises an organic compound selected from the group consisting of alcohols, glycols and mixtures thereof.

9. An electrochemical device in accordance with claim 8, wherein said at least one chemical additive comprises iso-propanol.

10. An electrochemical device in accordance with claim 8, wherein said at least one chemical additive comprises butanol.

11. An electrochemical device in accordance with claim 8, wherein said at least one chemical additive comprises ethylene glycol.

12. An electrochemical device in accordance with claim 6, wherein said electrochemical device is a direct methanol fuel cell.

13. An electrochemical device in accordance with claim 12, wherein said electrolyte is a polymer electrolyte membrane.

14. An electrochemical device in accordance with claim 13, wherein said electrolyte is fluorosulfonic acid.

15. In an electrochemical device comprising an electrolyte having an anode side and a cathode side, and at least one consumable carbonaceous material in solution disposed on said anode side, a method for reducing crossover of said at least one consumable carbonaceous material through said electrolyte to said cathode side comprising the steps of:
introducing at least one chemical additive into said solution whereby a chemical barrier is formed proximate to said electrolyte, said chemical barrier preventing crossover of at least a portion of said at least one consumable carbonaceous material through said electrolyte.

16. A method in accordance with claim 15, wherein an amount of said chemical additive remains substantially constant during operation of said electrochemical device.

17. A method in accordance with claim 15, wherein said electrochemical device is a direct methanol fuel cell and said at least one consumable carbonaceous material is methanol.

18. A method in accordance with claim 17, wherein said at least one chemical additive comprises at least one organic compound having a molecular size that is larger than a molecular size of said methanol.

19. A method in accordance with claim18, wherein said at least one chemical additive comprises an organic compound selected from the group consisting of alcohols, glycols and mixtures thereof.

20. A method in accordance with claim 19, wherein said at least one chemical additive comprises iso-propanol.

21. A method in accordance with claim 19, wherein said at least one chemical additive comprises butanol.

22. A method in accordance with claim19, wherein said at least one chemical additive comprises ethylene glycol.
